(19) United States
(12) Patent Application Publication
(10) Pub. No.: US 2021/0362161 A1
(43) Pub. Date: Nov. 25, 2021

(54) A REAGENT PREPARATION DEVICE

(71) Applicant: TOKU-E BIOTECH LABORATORY PTE. LTD., Singapore (SG)

(72) Inventor: Qiubao PAN, Singapore (SG)

(73) Assignee: TOKU-E BIOTECH LABORATORY PTE. LTD., Singapore (SG)

(21) Appl. No.: 16/772,303

(22) PCT Filed: Jan. 16, 2020
(86) PCT No.: PCT/SG20/50022

§ 371 Date: Jun. 12, 2020

(30) Foreign Application Priority Data
Jan. 17, 2019 (SG) 10201900431Q

(51) Int. Cl. B01L 3/00

(52) U.S. Cl. CPC B01L 3/523; B01L 3/5635; B01L 2200/0684; B01L 2300/044; B01L 2200/082; B01L 2300/0672; B01L 2300/042; B01L 2300/0832; B01L 2300/048

(57) ABSTRACT

A reagent preparation device (also called sterile and safe reagent preparation device) is disclosed for preparing a solution of a reagent, particularly a toxic chemical. The sterile and safe reagent preparation device comprises a liquid storage for storing a liquid (solvent or other fluid reactant); and a reagent (chemical or other reactant) container for containing a reagent. The liquid storage and the reagent container are configured to be detachably engaged. A method of making the sterile and safe reagent preparation device and a method of using the sterile and safe reagent preparation device are also disclosed in the present application.

### CROSS REFERENCE TO RELATED APPLICATIONS

This is a US non-provisional national phase entry patent application that claims priority to and benefit of Patent Cooperation Treaty patent application no. PCT/SG2020/050022, filed on Jan. 16, 2020, currently pending, which claims priority to and benefit of Singapore patent application no. 10201900431Q, which has the title of “A Sterile Reagent Preparation Device and the Method of using the same” filed on 17 Jan. 2019 and currently pending. All content and/or subject matter of the earlier PCT patent application and Singapore patent application are hereby incorporated by reference entirely or wherever appropriate and/or relevant.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND

### Technical Field

The present application relates to a reagent preparation device for sterilization and/or safety purposes, which is also called sterile and safe reagent preparation device herein for safely preparing a stock solution of a reagent, particularly a toxic chemical. The sterile and safe reagent preparation device comprises one or more liquid storages for storing a same liquid or different liquids and a reagent container for containing a reagent. The present application also discloses a method of making the sterile and safe reagent preparation device and a method of using the sterile and safe reagent preparation device.

### Prior Art

Many pharmaceutical reagents require preparation in a hygienic environment prior to use. Conventional reagent preparation device under a sterile condition such as in a hospital is a syringe having a nozzle and a piston. When in use, a syringe needle such as a steel needle is further installed onto the nozzle. An injection medicine in either liquid state or solid state is stored and sealed in a container and pure water or medical saline solution is kept in another bottle. Pure water or medical saline solution is first extracted by inserting the syringe needle into the bottle and pulling the piston backward. Then the extracted pure water or medical saline solution is injected into the container by pushing the piston forward; and the medicine is dissolved in the pure water or medical saline solution inside the container. However, the syringe with syringe needle as a reagent preparation device may have several drawbacks. Firstly, the medical reagents are handled by some personnel such as a nurse at the point of use. The quality of the reagents is easily compromised because of any error made during the preparation procedures. Even small errors may lead to an improperly prepared reagent, including but not limited to misusing the reagent, mis-measuring (i.e. erroneous measuring) the reagent and mis-diluting (i.e. erroneous diluting) the reagent. Secondly, the syringe and the syringe need to be completely sterilized and disinfected before usage and also kept away from any contamination from surrounding environment during the preparation procedures. Thirdly, some lyophilized reagents cannot be prepared by the syringe because the freeze-dried reagents would decrease their biological and chemical activities and thus damage the effectiveness by being exposed at room temperature for a relative long time. Therefore, a novel sterile and safe reagent preparation device is needed to replace the syringe with syringe needle resolve the existing challenges with the pharmaceutical reagents.

Meanwhile modern medical treatment such as cancer, genetic engineering or oncology diagnostics involves more and more highly toxic or even deadly reagents in solid state. The toxic solid reagents are usually prepared into sterile stock solutions by means of micro-filtration. But the current preparation method also has a major drawback. The toxic solid reagents must be frequently weighed by a research or an assistant before the micro-filtration process. The research or assistant may be dangerously exposed to the highly toxic reagents although a suitable personal protective equipment (PPE) has to be properly selected according to special toxicity of each of the reagents. The above method also needs laborious efforts to investigate the toxicity of each reagent in detail and arranges a great variety of PPEs if a large number of toxic reagents are used. Thus, the toxic reagents are often sold in sterile stock solutions that are less noxious. However, the stock solutions also have issues of stability and shipping. For example, a mixture of penicillin sodium and streptomycin sulfate is commonly used as an antibiotic in mammalian cell culture. Although the mixture is stable and potent in a solid state at room temperature, many people are allergic to penicillin powder. Hence, a stock solution of the mixture is often preferred for less risk. But penicillin is unstable in an aqueous solution such that its shelf life is less than two weeks at room temperature. It is so required to store the solution at 20 degrees below the freezing point (−20° C.) with help of dry ice. But shipping the solution at −20° C. is very troublesome and costly. Even if properly and carefully handled, the shelf life of the solution is still much shorter than that of the penicillin stored in a solid powder form. In addition, the quality of the reagents solution (the amount of the reagents solution, the purity of the reagents solution and the alike) cannot be guaranteed if a precise dosage is needed. Therefore, a novel sterile and safe reagent preparation device is provided to resolve the existing challenges with the solutions of the medical reagents.

In addition, current biomedical research has many active reagents commonly used for preparing stock solutions of the toxic reagents under a sterile condition in a laboratory, especially a cell culture laboratory for growing cell lines or a microbiology laboratory for growing microorganism. The stock solution is much more concentrated than an active reagent solution used in a laboratory. To prepare the active reagent solution, a portion of the stock solution is first transferred by using a pipet into a volumetric flask; and then the portion of the stock solution is precisely diluted to the mark of the volumetric flask for a pre-determined volume. Therefore, a novel device and the method of using thereof is needed for preparing a stock solution of the toxic reagent safely, quickly and precisely in the biomedical research.

Therefore, a novel sterile and safe reagent preparation device is disclosed in the present application for preparing a stock solution of a toxic reagent under a sterile condition in a laboratory, especially a cell culture laboratory or a microbiology laboratory. The sterile and safe reagent preparation device has several significant advantages over any of the conventional devices mentioned above. Firstly, the sterile and safe reagent preparation device can deal with highly toxic reagents used in the cell culture lab or the microbiology lab. Secondly, many components of the sterile and safe reagent preparation device are made of chemically stable plastics such that a great variety of reagents with different physical and chemical properties can be handled safely and properly. Thirdly, the sterile and safe reagent preparation device is applicable for preparing the stock solution in a wide range in terms of volume, ranging from 0.01 milliliter to several hundred milliliters. In particular, the stock solution has to be prepared in a quick manner. In summary, the sterile and safe reagent preparation device of the present application is distinguishably different from current dispensing devices; and is suitable for preparing stock solutions of highly toxic reagents in various fields such as pharmaceutical reagent preparation, medical treatment and biomedical research.

### BRIEF SUMMARY OF NON-LIMITING EXEMPLARY EMBODIMENT(S) OF THE PRESENT DISCLOSURE

In view of the foregoing background, it is therefore an object of the non-limiting exemplary embodiment(s) to provide a novel sterile and safe reagent preparation device is disclosed in the present application for preparing a stock solution of a toxic reagent under a sterile condition in a laboratory, especially a cell culture laboratory or a microbiology laboratory. The sterile and safe reagent preparation device has several significant advantages over any of the conventional devices mentioned above. Firstly, the sterile and safe reagent preparation device can deal with highly toxic reagents used in the cell culture lab or the microbiology lab. Secondly, many components of the sterile and safe reagent preparation device are made of chemically stable plastics such that a great variety of reagents with different physical and chemical properties can be handled safely and properly. Thirdly, the sterile and safe reagent preparation device is applicable for preparing the stock solution in a wide range in terms of volume, ranging from 0.01 milliliter to several hundred milliliters. In particular, the stock solution has to be prepared in a quick manner. In summary, the sterile and safe reagent preparation device of the present application is distinguishably different from current dispensing devices; and is suitable for preparing stock solutions of highly toxic reagents in various fields such as pharmaceutical reagent preparation, medical treatment and biomedical research.

As a first aspect, the present application discloses a reagent preparation device (also called sterile and safe reagent preparation device). The sterile and safe reagent preparation device comprises a liquid storage or fluid container for storing a liquid (solvent or other fluid reactant); and a reagent container for containing a reagent (such as chemical or other reactant) hermetically (airtight and securely). The liquid storage and the reagent container are configured to be detachably engaged together in forming an enclosure between the liquid storage and the reagent container for mixing the liquid and the reagent evenly or uniformly and for preventing leakage of the reagent and/or the liquid from the enclosure. The reagent may be either in a solid state or in a liquid state. The liquid storage may have any suitable vessel, such as an antiseptic cylinder; and the reagent container may also have any suitable repository, such as an antiseptic test tube. In addition, a gas or a mixture of gases may exist in the reagent container before the engagement. The gas might be air if the reagent is chemically inactive or an inert gas if the reagent is active to moisture and/or oxygen in the air. Alternatively, the reagent container may be vacuumed, which requires the reagent container to be strong enough for resisting the ambient pressure. The liquid storage is detached from the reagent container after the liquid is transferred completely from the liquid storage into the reagent container. The reagent solution may be immediately drained off or stored temporarily in the reagent container.

The liquid is pre-prepared and stored inside the liquid storage; and the liquid storage has a first volume capacity for accommodating the liquid. The liquid storage optionally has a volume capacity ranging from 1 milliliter (ml) to 100 milliliter (ml). Similarly, the reagent is also pre-prepared and stored inside the reagent container. Before being engaged, the liquid storage and the reagent container may be kept separated; and after being engaged, the liquid storage and the reagent container are seamlessly engaged such that no liquid would be leaked out of the sterile and safe reagent preparation device when the liquid is transferred from the liquid storage into the reagent container. A reagent solution is thus produced in the reagent container by dissolving the reagent with the liquid. The reagent container has a second volume capacity for accommodating both the reagent and the liquid or the reagent solution. Therefore, the second volume capacity of the reagent container needs to be larger than the first volume capacity of the liquid storage.

The reagent container has an impermeable membrane for sealing the reagent container for sealing the reagent container to avoid the powder reagent coming out of the reagent container. In particular, the membrane may substantially recover to its original state as an intact membrane for sealing the reagent container again after withdrawal of the sharp and tiny object from the reagent container. The membrane is made of chemically stable materials that can resist highly toxic reagents and various solvents. Meanwhile, the membrane can be pierced through by a sharp and tiny object before the solvent is injected into the reagent container. In addition, the membrane has a textured and sponge structure with a thickness ranging from 0.1 to 10 millimeters (mm), such that the membrane may substantially recover to its original state as an intact membrane for sealing the reagent container again after withdrawal of the sharp and tiny object from the reagent container. In this way, the membrane may prevent the reagent (such as in a powder form) in the reagent container to come out so that the device is safe to handle toxic chemicals. Therefore, before the engagement, the membrane seals the reagent inside the reagent container. After the stock solution is prepared in the reagent container, the membrane is used for sealing the stock solution inside the reagent container.

The membrane cannot be too thin nor too thick. If too thin, the membrane may be broken before, during or after the engagement of the liquid storage and the reagent container. The reagent, the liquid or the reagent solution may be thus leaked out of the reagent container. If too thick, the membrane may be not easily pierced or penetrated through during the engagement and thus the liquid cannot be transferred into the reagent container. In some implementations, the membrane has a thickness ranging from 0.1 millimeter (mm) to 10 millimeter (mm). In addition, the membrane may have a plurality of pores that help the membrane to recover after the engagement. The membrane can also be selected or designed according to the specific reagent and solvent in terms of material, thickness and pore size. The membrane optionally comprises at least one pore with a size ranging from 0.1 micrometer to 10 micrometers for the gas to flow into the reagent container, while the reagent powder cannot come out of the reagent container, it is an important safe feature of the device.

The liquid storage optionally comprises a communication part (also known as liquid communication part, conduit or channel) for the liquid to flow through from the liquid storage to the reagent container. In other words, the liquid in the liquid storage and the gas in the reagent container are transferred to the reagent container and the liquid storage through the communication part, respectively. In addition, if a gaseous substance is produced due to a chemical reaction between the reagent and the liquid when the reagent is dissolved in the liquid, the gaseous substance may be also transferred through the communication part into the liquid storage.

The communication part optionally comprises a first passageway for draining off the liquid stored in the liquid storage; and a second passageway for relieving or discharging a gas (such as air, inert gas) from the reagent container. The first passageway and the second passageway are substantially separated. The gas and/or resultant gaseous substance produced in the reagent container may also flow through the second passageway from the reagent container to the liquid storage while the liquid flows through the first passageway from the liquid storage to the reagent container.

The liquid storage optionally comprises a lid for sealing the first passageway and the second passageway. Meanwhile, the lid also protects the first passageway and the second passageway from any external shock or damage and any surrounding contamination. The lid is removed before the liquid storage is engaged with the reagent container. The liquid storage may further comprise a lid fastening mechanism for securely fastening the lid to the liquid storage. The lid fastening mechanism is unfastened before the lid is removed from the liquid storage. In some implementations, the lid fastening mechanism comprises an internal screw thread on the liquid storage; and an external screw thread on the lid. The external screw thread matches the internal screw thread. The lid fastening mechanism is unfastened by rotating the internal screw thread from the external screw thread. In particular, the internal screw thread and the external screw thread comprise an internal double thread and an external double thread respectively for enhancing an efficiency of lid fastening mechanism.

The communication part may further comprise a first inlet and a first outlet for the liquid to flow into and out of the first passageway, respectively; and a second inlet and a second outlet for the gas to flow into and out of the second passageway, respectively. The first inlet and the first outlet may be also used for foolproof coupling or guiding orientation between the liquid storage and the reagent container. The liquid flows from the liquid storage into the reagent container via the first inlet and the first outlet of the first passageway in sequence, which pushing the gas and/or the resultant gaseous substance to flow from the reagent container into the liquid storage via the second inlet and the second outlet of the second passageway. In some implementations, the first inlet and the second outlet are configured at one end of the communication part; and the first outlet and the second inlet are configured at another end of the communication part opposed to the first inlet and the second outlet, respectively.

The first passageway and the second passageway have a first cross-sectional area and a second cross-sectional area, respectively. The second cross-sectional area should be smaller than the first cross-sectional area for avoiding a balance of the liquid in the liquid storage. In the balance of the liquid, the liquid in the liquid storage would not flow through the communication part even if the liquid storage is vibrated or shaken. An area ratio of the first cross-sectional area to the second cross-sectional area is used to indicate the balance of the liquid. The area ratio is optionally in a range from 1.5 to 64. For example, when both the first cross-sectional area and the second cross-sectional area have round shape, i.e. the first passageway and the second passageway have a first diameter and a second diameter measured at two opposed internal side surfaces respectively, i.e. a first internal diameter and a second internal diameter. The area ratio thus may also be expressed as a diameter ratio of the first diameter to the second diameter. The diameter ratio is optionally in a range from 1.2 to 8.0. The smaller volume capacity the liquid storage has, the larger the area ratio should be. For example, the area ratios are around 1.5 and 64 when the first volume capacities of the liquid storage are around 100 milliliter (ml) and 1 milliliter (ml). In some implementations, the area ratio is substantially around 9.

The liquid storage may further comprise an opening cover opposed to the communication part for covering an opening. The opening is used for filling in the liquid into the liquid storage. The liquid may be dispensed from a stock of the liquid by any known device such as dispenser, pipet, volumetric flask (also known as measuring flask or graduated flask), measuring cylinder, measuring breaker or measuring tube. The opening is tightly fastened or sealed to the liquid storage for preventing any leakage of the liquid from the opening. In this way, a precise amount of the liquid is prepared into the liquid storage.

In some implementations, the communication part further comprises a case defining an internal cavity; and a baffle inside the case for separating the internal cavity into the first passageway and the second passageway. In other words, the first passageway and the second passageway are enclosed by the case and separated by the baffle. The communication part may have any suitable dimension. The internal cavity optionally has a cross-sectional area ranging from 1 millimeter square to 100 millimeter square. For example, if the internal cavity has a cylindrical dimension having a circular shape in a cross-sectional view, the cross-sectional area is measured by an inside diameter. The inside diameter is in a range from 1 to 10 millimeter (mm), accordingly.

In particular, the baffle optionally has a baffle edge or sharp edge (such as a needle or a blade) for piercing or penetrating through the membrane of the reagent container. The baffle edge may be at or near the first outlet of the first passageway and the second inlet of the second passageway. In this way, the communication part is partially inserted into the reagent container after the baffle edge pierces the membrane. Therefore, the first passageway and the second passageway are communicated with the reagent container for the liquid and the gas and/or resultant gaseous substance, respectively. The baffle edge is required to be sharp enough for piercing or penetrating through the membrane, but not too sharp for safety consideration. The sterile and safe reagent preparation device is designed to be commonly used for preparing a stock solution of a toxic reagent under a sterile condition in a laboratory, such as a cell culture laboratory or a microbiology laboratory without the personnel expose to the powder of toxic reagent. A lab technician has to work in a safety hood where internal space is usually very limited. Thus, a very sharp baffle edge may be dangerous to the technician or any person around him or simply passing by him. The baffle edge optionally has a cut angle ranging from 10 degrees to 45 degrees for meeting the two contradictory requirements above.

In some implementation, the communication part optionally comprises a head configured to be assembled to the liquid storage; a first cannula extending out of the head as the first passageway; and a second cannula extending out of the head as the second passageway. The first cannula and the second cannula are two independent components. In other words, the first cannula and the second cannula are not enclosed by a common case, Instead, the first cannula and the second cannula are enclosed by a first enclosure and a second enclosure, respectively.

The first cannula and the second cannula may have any suitable dimension. For example, the first cannula and the second cannula have a first cylindrical dimension and a second cylindrical dimension, respectively. The first cylindrical dimension and the second cylindrical dimension have a first diameter and a second diameter in their cross-sectional views, respectively. similar to the area ratio, a diameter ratio of the first diameter to the second diameter is used to indicate the balance of the liquid. The diameter ratio has a range from 1.2 to 8.0. The smaller volume capacity the liquid storage has, the larger the diameter ratio should be. For example, the diameter ratios are around 1.2 and 8 when the first volume capacities of the liquid storage are around 100 milliliter (ml) and 1 milliliter (ml). In some implementations, the diameter ratio is around 3.0. In addition, the first diameter and the second diameter are in a range from 1 millimeter (mm) to 10 millimeter (mm). In particular, the first diameter cannot be too small for avoiding surface tension of the liquid.

The first cannula and the second cannula have a first cannula edge and a second cannula edge for piercing through the membrane, respectively. In some implementations, the first cannula edge and the second cannula edge are configured at or near the first outlet of the first cannula and the second inlet of the second cannula. The lid covers the first cannula edge and the second cannula edge for preventing the first cannula edge and the second cannula from causing any injuries to an operator or other staffs around the operator. The first edge and the second edge have a first cut angle and a second cut angle. Similar to the baffle edge, the first edge and the second edge are inn a range from 10 degrees to 45 degrees respectively for meeting the two requirements above.

The head of the liquid storage optionally comprises a conduit connected to the first cannula. The conduit communicates the liquid with the first cannula. In other words, the liquid flows from the liquid storage to the first cannula via the conduit. The conduit may have a larger size than the first cannula for avoiding any congestion between the conduit and the first cannula. In particular, the conduit has a first portion and a second portion embedded inside the head and exposed out of the head respectively.

The liquid storage may further comprise a frame enclosing the conduit; and a flipper for sealing and releasing the liquid. The flipper is configured to be at an opposite side of the first cannula when coupling the liquid storage and the reagent container together. In other words, the flipper and the first cannula are connected at two opposite ends of the conduit. In particular, the flipper is flipped open only in one direction away from the first cannula. Therefore, the conduit may push the flipper to open for draining off the liquid from the liquid storage to the first cannula. In addition, the flipper is used as a sealing layer for isolating the stored liquid from outside environment. When not in use, the liquid storage is positioned vertically with the head and the first cannula at a bottom side and the flipper at a top side. In this way, the liquid stored above the flipper is sealed by the flipper and would not flow into the conduit and the first cannula under the gravity.

The liquid storage optionally further comprises a movable shell for enclosing the liquid storage; and the moveable shell moves along the frame. The movable shell may move between a full position indicating that the liquid storage is full of the liquid and an empty position indicating that the stored liquid is completely drained off. When the liquid storage is at the full position, the second portion of the conduit is completely exposed out of the movable shell; the second portion is gradually enclosed by the movable shell when the movable moves towards the head; and finally the movable shell reaches the head and the section portion is thus completely enclosed by the movable shell when the liquid storage is at the empty position. The movable shell moves from the full position to the empty position for pushing the stored liquid to drain off the liquid storage. In detail, the first and second cannulas are inserted into the reagent container, and the flipper is pushed open by sliding the movable shell forwardly or pulling the head backwardly. In this way, the stored liquid is released from the liquid storage and flows into the reagent container across the flipper and through the conduit and the first cannula in sequence.

In some implementations, two or more different liquids are needed to dissolve the reagent. Therefore, two or more liquid storages storing the respective liquids may be engaged to the reagent container of the sterile and safe reagent preparation device in sequence. In this case, the second volume capacity of the reagent container should be large enough for accommodating the reagent and both or all the different liquids.

The reagent container optionally comprises a cap detachable from the reagent container and is also re-sealable with the reagent container. In addition to the membrane, the cap also seals the reagent inside the reagent container. When not in use, the reagent container is positioned vertically with the cap on a top side. In addition, the cap may be also detachable from the liquid storage if the reagent container and the liquid storage are connected at two opposite ends of the cap when the liquid storage is engaged with the reagent container. In some implementations, the cap is configured for receiving the two or more cannulas of the liquid reservoir. For example, the cap comprises a first hole and a second hole aligned with the first cannula and the second cannula respectively. During the engagement, the first cannula and the second cannula are inserted through the first hole and the second hole of the cap, respectively before reaching the membrane.

The cap optionally comprises a first fastening mechanism for detachably fastening the cap to the reagent container; and a second fastening mechanism for detachably fastening the cap to the liquid storage. The first fastening mechanism optionally comprises a first male screw thread on the reagent container; and a first female screw thread on a first end of the cap. The first male screw thread matches the first female screw thread. In some implementations, the first female screw thread and the first male screw thread comprise a first female double thread and a first male double thread respectively for enhancing a first efficiency of the first fastening mechanism. Similarly, the second fastening mechanism optionally comprises a second male screw thread on the liquid storage; and a second female screw thread on a second end of the cap. The first male screw thread matches the first female screw thread. The second male screw thread may be referred to the external screw thread of the liquid storage. In some implementations, the second female screw thread and the second male screw thread comprise a second female double thread and a second male double thread respectively for enhancing a second efficiency of the second fastening mechanism.

The cap optionally comprises a cover for sealing the reagent container. The cover may be configured to open from the reagent container. The cover is located at or near the second end of the cap. In some implementations, the cap is flipped open with a linkage to the cap. The linkage may be either permanently linked to the cap (such as a plastic strip molded together with a plastic cap) or temporarily linked to the cap (such as a rope tied to the cap). The cover also seals the reagent or the reagent solution inside the reagent container. Therefore, the sterile and safe reagent preparation device has a double sealing mechanism for preventing the reagent before engagement or the stock solution after the engagement from leakage.

The reagent container comprises a body for defining a bottom side, a left side and a right side of the reagent container. The body of the reagent container has three distinctive functions in three different stages. The body is used for containing the reagent before the engagement, for acting as a reactor during mixing the reagent with the stored liquid, and for storing the reagent solution after usage. Therefore, the body of the reagent container has to be made of a chemically inert material that can resist the reagent, the solvent and the mixture or the stock solution. The cap completely covers the top side of the body for sealing the reagent or the stock solution inside the reagent container.

Since the liquid flows through the communication part, the communication part is optionally made of chemically stable plastics, such as polypropylene (PP), polytetrafluoroethene (PTFE), polyethylene terephthalate (PETG) or any combination thereof. Similarly, since the membrane may be in direct contact with the reagent, the liquid and/or the reagent solution, the membrane is made of chemically stable plastics or chemically resistant material, such as polypropylene (PP), Nylon materials, polytetrafluoroethene (PTFE), polyethylene terephthalate (PETG) or any combination thereof.

As a second aspect, the present application discloses another sterile and safe reagent preparation device. The sterile and safe reagent preparation device comprises one or more liquid reservoirs such as an antiseptic cylinder for storing solvents and one or more reagent containers such as an antiseptic test tube for containing reagents. The liquid reservoirs and the reagent containers exist as individual components that are kept separately before mixing the reagents with the solvents stored in the liquid reservoirs (i.e. stored solvents).

Each of the liquid reservoirs comprises a movable shell, a flipper inside the movable shell, two or more cannulas outside the movable shell and a head connecting the flipper and the cannula. The movable shell defines a bottom side, a left side and a right side of the liquid reservoir. The movable shell can move between a full position denoting the liquid reservoir is filled with a stored solvent and an empty position denoting the stored solvent is completely drained off. When the stored solvent is drained off from the liquid reservoir, the movable shell moves from the full position to the empty position. The flipper is located inside the movable shell and used as a sealing layer for isolating the stored solvent from outside environment. When not in use, the liquid reservoir is positioned vertically with the head and cannulas on the top; and the flipper is used for sealing the solvent that is inside the liquid reservoir and below the flipper. When in use that the two or more cannulas are inserted into the reagent container, the flipper is pushed open by sliding the movable shell forward or pulling the head backward. In this way, the stored solvent is released from the liquid reservoir and flows into the reagent container. The head is used for connecting the flipper and the cannulas. The cannulas are used for draining off the stored solvent and releasing the toxic gas in the reagent container. If two or more types of stored solvents are needed, more liquid reservoirs can be used in the sterile and safe reagent preparation device accordingly. Each of the reagent containers comprises a body and a cap. The body defines a bottom side, a left side and a right side of the reagent container. When not in use, the reagent container is positioned vertically with the cap on the top; and the cap has a double sealing mechanism for sealing the toxic reagent stored inside the reagent container. In the present application, the body of the reagent container has distinctive functions in different stages. The body is used for containing the reagent before usage, for acting as a reactor during mixing the reagent with the stored solvent, and for storing the reagent-solvent mixture as a stock solution after usage. Therefore, the body of the reagent container has to be made of a chemically inert material that can resist the reagent, the solvent and the mixture or the stock solution. The cap completely covers the top side of the body for sealing the reagent or the stock solution inside the body. The cap is configured for receiving the two or more cannulas of the liquid reservoir.

The head of each liquid reservoirs has a frame and a conduit. The frame is connected to the movable shell such that the movable shell can move along the frame within a limited distance from the full position to the empty position. In detail, the frame further has a first portion, a second portion and a dent for connecting the first portion and the second portion. The first portion of the frame is always located outside the movable shell and defines the outside boundary of the liquid reservoir with the movable shell. The second portion of the frame may become gradually enclosed inside the movable shell when the movable shell moves from the full position to the empty position. When the movable shell is fixed at the full position, the second portion of the frame is almost completely exposed outside the movable shell. On the contrary, when the movable shell moves to the dent of the frame where the empty position is denoted, the second portion of the frame is almost completely enclosed inside the movable shell. The second portion of the frame and the movable shell need to be precisely matched in the way that the solvent stored inside the liquid reservoir would not leak outside when the movable shell moves along the frame of the head. In other words, the external surface of the second portion need to be in direct and tight contact with the internal surface of the movable shell. The conduit of the head is completely formed inside the movable shell and the head. Particularly, the conduit is connected beneath the flipper such that the conduit pushes the flipper open when the movable shell moves from the full position to the empty position. Hence, the solvent stored in the liquid reservoir can flow across the flipper, along the conduit and to the cannula by simply moving the movable shell.

The liquid reservoir may have two or more cannulas, each of which is almost completely or partially outside the movable shell. Each of the cannulas has a first end connected to the conduit and a second end located outside the movable shell. The second end is required to be sharp enough to penetrate through the corresponding part (i.e. the membrane) of the reagent container, but not too sharp for safety consideration. The sterile and safe reagent preparation device is mainly used for preparing a stock solution of a toxic reagent under a sterile condition in a laboratory, such as a cell culture laboratory or a microbiology laboratory without the personnel exposes to the toxic reagent powder. A lab technician has to work in a safety hood where internal space is usually very limited. Thus, a very sharp second end of cannula may be dangerous to the technician or any person around him or simply passing by him. To meet both the requirements above, the second end has a cut angle ranging from 10 degrees to 45 degrees. In addition, a protective lid may be installed onto the second end of the cannula for avoiding any accident and particularly safeguarding an operating staff while the stored solvent is harmful to human. Meanwhile, the protective lid also protects the second end of the cannula from external contamination and damage. The cannula also needs to resist the solvent stored in the liquid reservoir and the reagent contained in the reagent container. In contrast to the steel syringe needle conventionally used in the syringe, the cannulas are preferably made of chemically stable plastics, such as polypropylene (PP), polytetrafluoroethene (PTFE), polyethylene terephthalate (PETG) or any combination thereof.

The two or more cannulas are used for draining off the solvent stored in the liquid reservoir and releasing the toxic gas in the reagent container for avoiding any toxic materials leaking out of the reagent container to the surrounding environment. Since the sterile and safe reagent preparation device is applicable for preparing the stock solution in a wide range from 0.01 milliliter (i.e. milliliter) to several hundred milliliters a quick manner, the cannula can be too small in radial size. If the diameter is too small, the stored solvent may not smoothly and easily flow out of the cannulas due to surface tension at the second end of the cannula; and the preparation process may take a longer period particularly when the stored solvent has a high viscosity. The diameter of the cannula preferably ranges from 1 mm to 5 mm according to a specific design. Two or more cannulas are adopted, each of the cannulas may have different diameters because at least one of the cannulas is exclusively used for releasing the toxic gas from the reagent container to the liquid reservoir. Therefore, the cannula is one of the key technical features of the subject application.

The cap of the reagent container has a left portion, a top portion and a right portion such that the cap is contoured for completely sealing the opening of the body. The top portion of the cap has two or more holes, each of which would be peered through by one of the cannulas during preparation of the stock solution. The cap cover of the reagent container comprises two or more protruding parts located on the bottom surface of the cap cover. Each of the two or more protruding parts is used for blocking and covering one of the two or more holes. Thus, the number and the layout of the protruding parts are the same as these of the holes. To tightly block each of the holes, the protruding part has a same shape of the hole with such a slightly larger size that the protruding part can just tightly fit into the hole. The cap cover has distinctive functions at different stages of operation. Before usage, the cap cover is integrated with the cap as a whole to prevent the reagent contained inside the reagent container from leakage as well as contamination by the surrounding environment. Right before preparing the stock solution, the cap cover with the two or more protruding parts is first removed from the reagent container; as a result, the two or more holes are exposed. Meanwhile, the membrane of the reagent container below the cap is partially exposed from the holes. The cannulas are then inserted into the holes, peered through the membrane and finally pushed into the reagent container. Therefore, the protruding parts are so designed to match the layout of the cannulas in terms of number, location and size.

The cap cover is another key technical features of the subject application. In contrast to the conventional rubber cap cover that is unstable to many reagents or solvents, the cap of the reagent container here is preferably made of chemically stable plastics, such as polypropylene (PP), polytetrafluoroethene (PTFE), polyethylene terephthalate (PETG) or any combination therefore.

The membrane of the reagent container is located near the opening of the body and below the cap cover. The reagent is contained below the membrane that protects the reagent from leakage as well as contamination. The membrane of the present application has several advantages. Firstly, since the membrane may be in direct contact with the toxic reagent and the solvent, the membrane is particularly made of chemically stable plastics, such as polypropylene (PP), polytetrafluoroethene (PTFE), polyethylene terephthalate (PETG) or any combination thereof. Secondly, the membrane should not so hard and stiff such that it can be peered through by the plastic cannulas before the solvent is injected into the reagent container. Thirdly, the membrane has a textured surface and a pre-determined thickness such that the membrane can substantially recovers to the original state as an intact membrane and then seals the reagent container again after the cannulas are withdrawn from the membrane. After the stock solution is prepared in the reagent container, the cap cover and the membrane are both closed to provide double sealing mechanisms for preventing the stock solution from leakage. Preferably, the membrane may have a thickness ranging from 0.1 mm to 5 mm. In addition, the membrane may have a plurality of pores that help the membrane to recover after the cannulas are withdrawn from the membrane. Preferably, the size of the pore ranges from 0.1 micrometer (i.e. micrometer) to 10 micrometers. The membrane can also be selected or designed according to the specific reagent and solvent in terms of material, thickness and pore size.

In summary, the sterile and safe reagent preparation device of the present application is mainly used for preparing a stock solution of a toxic reagent under a sterile condition in a laboratory, especially a cell culture laboratory or a microbiology laboratory without the personnel exposes to the toxic reagent powder. The sterile and safe reagent preparation device has several significant advantages over any of the conventional devices mentioned above. Firstly, the sterile and safe reagent preparation device can deal with highly toxic reagents used in the cell culture lab or the microbiology lab. In particular, the sterile and safe reagent preparation device adopts a flipper for covering a cap so that the highly toxic reagents are safely contained in the sterile and safe reagent preparation device without any leakage during preparation. Secondly, many components of the sterile and safe reagent preparation device are made of chemically stable plastics such that a great variety of reagents with different physical and chemical properties can be handled safely and properly. For example, a plastic cannula (i.e. needle) is used instead of a conventional steel needle for transferring stored solvents to be mixed with the toxic reagents, because the steel needle is not chemically stable to certain solvents having chlorides. In addition, the plastic cannula is not as sharp as the steel needle so that a human operator or anyone around the human operator can be better protected. Thirdly, the sterile and safe reagent preparation device is applicable for preparing the stock solution in a wide range in terms of volume, ranging from 0.01 milliliter to several hundred milliliters. In particular, the stock solution has to be prepared in a quick manner. The sterile and safe reagent preparation device can meet this requirement by adjusting a diameter of the plastic cannula to a certain range. Meanwhile, the cap also has a hole that matches the size of the plastic cannula. In this way, the plastic cannula can penetrate through the hole smoothly and safely. In summary, the sterile and safe reagent preparation device is suitable for preparing stock solutions of highly toxic reagents used primarily in laboratories due to the novel features mention above. Therefore, the present application is distinguishably different from any of the existing reagent preparation in a laboratory and/or dispensing device in the medical and pharmaceutical field.

As a third aspect, the present application discloses a method of making the sterile and safe reagent preparation device of the first aspect. The method of making the sterile and safe regent preparation device comprises a step of providing a liquid storage for storing a liquid; and a step of providing a reagent container for containing a reagent. The liquid storage and the reagent container are configured to be detachably engaged. In some implementations, the liquid storage and/or the reagent container are/is fabricated as a whole. For example, the liquid storage or the reagent container are molded as a single apparatus. Alternatively, the liquid storage and/or the reagent container are/is assembled by multiple components into a unitary apparatus.

The step of providing the reagent container optionally comprises assembling a membrane for sealing the reagent container. The step of providing the liquid storage optionally comprises a step of providing a communication part; and a step of assembling the communication part for the liquid to flow through from the liquid storage to the reagent container.

The step of providing the communication part optionally comprises making a baffle in the communication part for forming a first passageway for draining off the liquid and a second passageway for reliving a gas from the reagent container. The step of making the baffle optionally comprises creating a baffle edge for piercing through the membrane.

The step of providing the communication part optionally comprises making a first cannula as a first passageway for draining off the liquid and a second cannula as a second passageway for reliving a gas from the reagent container. The step of making the first cannula and the second cannula optionally comprises creating a first cannula edge and a second cannula edge for piercing through the membrane.

The step of providing the liquid storage may further comprise fastening a lid for sealing the first passageway and the second passageway.

The step of providing the reagent container optionally comprises a step of providing a cap; and a step of fastening a cap to the reagent container and the liquid storage. The step of providing the cap optionally comprises linking a cover to the cap for sealing the reagent container.

As a fourth aspect, the present application discloses a method of using the sterile and safe reagent preparation device of the first aspect. The method of using the sterile and safe reagent preparation device comprises a step of providing a liquid storage for storing a liquid; a step of providing a reagent container for containing a reagent; a step of engaging the liquid storage to the reagent container; a step of transferring the liquid from the liquid storage to the reagent container; and a step of detaching the liquid storage from the reagent container.

The step of providing the liquid storage optionally comprises filling in the liquid into the liquid storage via an opening of the liquid storage.

The step of engaging the liquid storage optionally comprises piercing a membrane of the reagent container using a communication part of the liquid storage.

The step of engaging the liquid storage optionally further comprises fastening the liquid storage to the reagent container.

The step of engaging the liquid storage optionally further comprises a step of opening a cover from a cap of the reagent container; and a step of inserting the communication part into the cap.

The step of transferring the liquid optionally comprises injecting the liquid via the communication part of the liquid storage. The step of injecting the liquid optionally comprise flipping over the liquid storage. The step of injecting the liquid optionally comprises pushing a moveable shell of the liquid storage.

The step of detaching the liquid storage optionally comprises a step of unfastening the liquid storage from the reagent container; and a step of withdrawing the communication part out of the reagent container.

The method of using the sterile and safe reagent preparation device optionally further comprises dissolving the reagent with the liquid within the reagent container.

As a fifth aspect, the present application discloses another method of using the sterile and safe reagent preparation device of the first aspect. The method of using the sterile and safe reagent preparation device comprises the following steps. Firstly, remove the cover (also known as cap cover) from the cap of the reagent container. In the first step, the protruding parts are removed from the holes of the cap. Secondly, remove the protective lid from the second end of each cannula of the liquid storage (also known as liquid reservoir). Thirdly, insert the one or more cannulas into the holes of the cap accordingly, and further peer through the membrane. Fourthly, open the flipper by pushing the movable shell forward or pulling the head backward from the full position to the empty position. Fifthly, the stored solvent is injected into the reagent container by flowing across the flipper to the conduit and the one or more cannulas. Meanwhile, the toxic air inside the reagent container is transferred into the liquid reservoir through the cannulas, the conduit and across the flipper. The toxic air is prevented from leakage outside to the surrounding environment. Sixthly, withdraw the liquid reservoir from the reagent container by extracting the cannulas out of the membrane and the holes of the cap. After the sixth step, the cannulas exposed outside the head may undergo an antiseptic process and/or a drying process. And seventhly, reset the flipper by pulling the movable shell backward from the empty position to the full position. In the seventh step, another same or different solvent may be refilled into the liquid reservoir such that the sterile and safe reagent preparation device is reusable without any contamination.

There has thus been outlined, rather broadly, the more important features of non-limiting exemplary embodiment(s) of the present disclosure so that the following detailed description may be better understood, and that the present contribution to the relevant art(s) may be better appreciated. There are additional features of the non-limiting exemplary embodiment(s) of the present disclosure that will be described hereinafter and which will form the subject matter of the claims appended hereto.

### BRIEF DESCRIPTION OF THE NON-LIMITING EXEMPLARY DRAWINGS

The novel features believed to be characteristic of non-limiting exemplary embodiment(s) of the present disclosure are set forth with particularity in the appended claims. The non-limiting exemplary embodiment(s) of the present disclosure itself, however, both as to its organization and method of operation, together with further objects and advantages thereof, may best be understood by reference to the following description taken in connection with the accompanying drawings in which:

FIG. 1 illustrates a perspective view of a first sterile and safe reagent preparation device;

FIG. 2 illustrates a flowchart of a method of using the first sterile and safe reagent preparation device;

FIG. 3 illustrates an exploded view of a second sterile and safe reagent preparation device;

FIG. 4 illustrates a liquid storage of the second sterile and safe reagent preparation device;

FIG. 5 illustrates a communication part of the liquid storage;

FIG. 6 illustrates an opening cover of the liquid storage;

FIG. 7 illustrates a lid of the liquid storage;

FIG. 8 illustrates a body of the reagent container of the second sterile and safe reagent preparation device;

FIG. 9 illustrates a bottom view of the body of the reagent container;

FIG. 10 illustrates an isometric view of a first embodiment of a cap of the reagent container;

FIG. 11 illustrates a cross-sectional view of the first embodiment of the cap;

FIG. 12 illustrates a top view of the first embodiment of the cap;

FIG. 13 illustrates a side view of a second embodiment of the cap; and

FIG. 14 illustrates a flowchart of a method of using the second sterile and safe reagent preparation device.

Those skilled in the art will appreciate that the figures are not intended to be drawn to any particular scale; nor are the figures intended to illustrate every non-limiting exemplary embodiment(s) of the present disclosure. The present disclosure is not limited to any particular non-limiting exemplary embodiment(s) depicted in the figures nor the shapes, relative sizes or proportions shown in the figures.

### DETAILED DESCRIPTION OF NON-LIMITING EXEMPLARY EMBODIMENT(S) OF THE PRESENT DISCLOSURE

The present disclosure will now be described more fully hereinafter with reference to the accompanying drawings, in which non-limiting exemplary embodiment(s) of the present disclosure is shown. The present disclosure may, however, be embodied in many different forms and should not be construed as limited to the non-limiting exemplary embodiment(s) set forth herein. Rather, such non-limiting exemplary embodiment(s) are provided so that this application will be thorough and complete, and will fully convey the true spirit and scope of the present disclosure to those skilled in the relevant art(s). Like numbers refer to like elements throughout the figures.

The illustrations of the non-limiting exemplary embodiment(s) described herein are intended to provide a general understanding of the structure of the present disclosure. The illustrations are not intended to serve as a complete description of all of the elements and features of the structures, systems and/or methods described herein. Other non-limiting exemplary embodiment(s) may be apparent to those of ordinary skill in the relevant art(s) upon reviewing the disclosure. Other non-limiting exemplary embodiment(s) may be utilized and derived from the disclosure such that structural, logical substitutions and changes may be made without departing from the true spirit and scope of the present disclosure. Additionally, the illustrations are merely representational are to be regarded as illustrative rather than restrictive.

One or more embodiment(s) of the disclosure may be referred to herein, individually and/or collectively, by the term “non-limiting exemplary embodiment(s)” merely for convenience and without intending to voluntarily limit the true spirit and scope of this application to any particular non-limiting exemplary embodiment(s) or inventive concept. Moreover, although specific embodiment(s) have been illustrated and described herein, it should be appreciated that any subsequent arrangement designed to achieve the same or similar purpose may be substituted for the specific embodiment(s) shown. This disclosure is intended to cover any and all subsequent adaptations or variations of other embodiment(s). Combinations of the above embodiment(s), and other embodiment(s) not specifically described herein, will be apparent to those of skill in the relevant art(s) upon reviewing the description.

References in the specification to “one embodiment(s)”, “an embodiment(s)”, “a preferred embodiment(s)”, “an alternative embodiment(s)” and similar phrases mean that a particular feature, structure, or characteristic described in connection with the embodiment(s) is included in at least an embodiment(s) of the non-limiting exemplary embodiment(s). The appearances of the phrase “non-limiting exemplary embodiment” in various places in the specification are not necessarily all meant to refer to the same embodiment(s).

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiment(s) and are not necessarily intended to be construed as limiting.

If used herein, “about” means approximately or nearly and in the context of a numerical value or range set forth means ±15% of the numerical.

If used herein, “substantially” means largely if not wholly that which is specified but so close that the difference is insignificant.

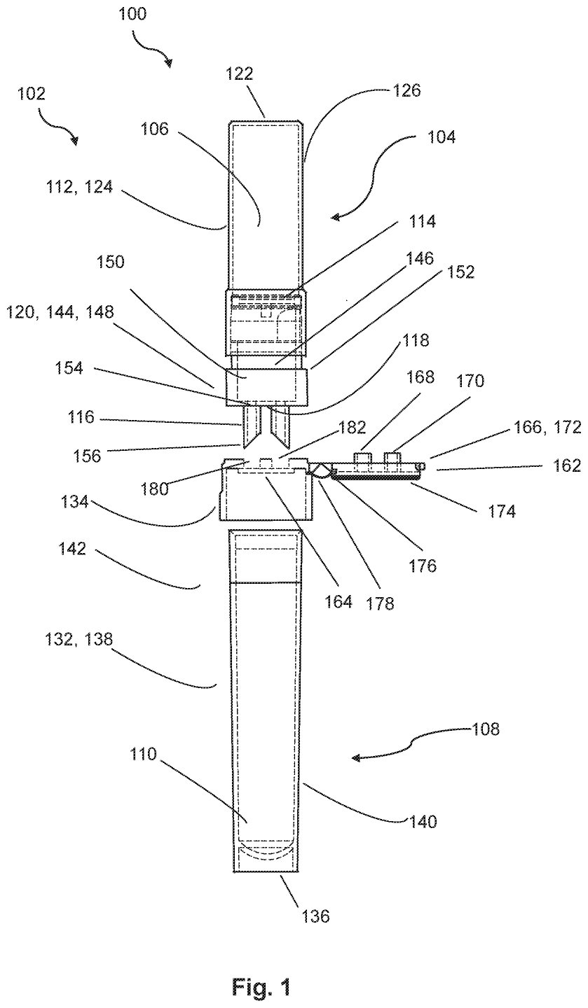

FIG. 1 shows the first embodiment 100 of a sterile and safe reagent preparation device (i.e. first sterile and safe reagent preparation device 102) of the subject application. The first sterile and safe reagent preparation device 102 comprises a liquid reservoir 104 for storing a solvent 106 and a reagent container 108 for containing a reagent 110. The liquid reservoir 104 and the reagent container 108 exist as individual components that are not connected before mixing the reagent 110 with the solvent 106 stored in the liquid reservoir 104 (i.e. stored solvent 106).

The liquid reservoir 104 comprises a movable shell 112, a flipper 114 inside the movable shell 112, a first cannula 116 and a second cannula 118 outside the movable shell 112 and a head 120 connecting the flipper 114 and the first and second cannulas 116 and 118. The movable shell 112 defines a bottom side 122, a left side 124 and a right side 126 of the liquid reservoir 104. The movable shell 112 can move between a full position 128 (not shown) denoting that the liquid reservoir 104 is fully filled with a stored solvent 106 and an empty position 130 (not shown) denoting that the stored solvent 106 is completely drained off. When the stored solvent 106 is drained off from the liquid reservoir 104, the movable shell 112 moves from the full position 128 to the empty position 130. The flipper 114 is located inside the movable shell 112 and used as a sealing layer for isolating the stored solvent 106 from the outside environment. When in use, the flipper 114 can release the stored solvent 106 in the liquid reservoir 104. The head 120 is used for connecting the flipper 114 and the cannulas 116 and 118. The first cannula 116 is used for draining off the stored solvent 106; while the second cannula 118 is used for releasing toxic gas in the reagent container 108. The reagent container 108 comprises a body 132, a cap 134, a cap cover 162 and a membrane 164. The body 132 defines a bottom side 136, a left side 138 and a right side 140 of the reagent container 108. In the present application, the body 132 is used for containing the reagent 110 before preparation, acting as a reactor during mixing the reagent 110 with the stored solvent 106, and for storing the reagent-solvent mixture as a stock solution after preparation. Therefore, the body 132 of the reagent container 108 is made of a chemically inert material that can resist the reagent 110, the solvent 106 and the stock solution. The cap cover 162 and the membrane 164 completely cover the opening of the body 132 at the top side 142 for sealing the reagent 110 inside the body 132. The cap 134 is configured for receiving the two cannulas 116 and 118 of the liquid reservoir 104 at the same time.

The head 120 of the liquid reservoir 104 has a frame 144 and a conduit 146. The frame 144 is connected to the movable shell 112 such that the movable shell 112 can move along the frame 144 within a limited distance. In detail, the frame 144 further has a first portion 148, a second portion 150 and a dent 152 for connecting the first portion 148 and the second portion 150. The first portion 148 of the frame 144 is always located outside the movable shell 112 and defines the outside boundary of the liquid reservoir 104 with the movable shell 112. The second portion 150 of the frame 144 may become gradually enclosed inside the movable shell 112 when the movable shell 112 moves from the full position 128 to the empty position 130. When the movable shell 112 is fixed at the full position 128, the second portion 150 of the frame 144 is almost completely exposed outside the movable shell 112. On the contrary, when the movable shell 112 moves to the dent 152 of the frame 144 where the empty position 130 is denoted, the second portion 150 of the frame 144 is almost completely enclosed inside the movable shell 112. The second portion 150 of the frame 144 and the movable shell 112 need to be just matched in the way that the stored solvent 106 inside the liquid reservoir 104 would not leak outside when the movable shell 112 moves along the frame 144. In other words, the external surface of the second portion 150 needs to be in direct and tight contact with the internal surface of the movable shell 112. The conduit 146 is completely inside the movable shell 112 and the frame 144. Particularly, the conduit 146 is connected beneath the flipper 114 such that the conduit 146 pushes the flipper 114 open when the movable shell 112 moves from the full position 128 to the empty position 130. Hence, the stored solvent 106 in the liquid reservoir 104 can flow across the flipper 114 and the conduit 146 to the cannula 116 by simply pushing the movable shell 112 forward.

As shown in FIG. 1, the liquid reservoir 104 has two cannulas 116 and 118, each of which has a first end 154 connected to the conduit 146 and a second end 156 always located outside the movable shell 112. The second end 156 is required to be sharp enough to penetrate through the membrane 164, but not too sharp for safety consideration. To meet the requirements, the second end 156 has a cut angle ranging from 10 degrees to 45 degrees. In addition, two protective lids 158 (not shown) are installed onto the second ends 156 of the cannulas 116 and 118 for avoiding any accident and particularly safeguarding an operating staff. Meanwhile, the protective lids 158 also protects the second ends 156 of the cannulas 116 and 118 from external contamination. The cannulas 116 and 118 also need to resist the stored solvent 106. Thus the cannulas 116 and 118 are preferably made of chemically stable plastics, such as polypropylene (PP), polytetrafluoroethene (PTFE), polyethylene terephthalate (PETG) or any combination thereof.

In the first embodiment 100, the first cannulas 116 is used for draining off the stored solvent 106 in the liquid reservoir 104; while the second cannula 118 is used for conducting an air exchange 160 between the reagent container 108 and the liquid reservoir 104. Thus, the cannulas 116 and 118 can have a same or a different diameter that preferably ranges from 1 mm to 5 mm. Since the first cannula 116 is used for draining off the stored solvent 106, the diameter of the first cannula 116 is usually determined by a viscosity of the stored solvent 106. The higher the viscosity is, the larger the diameter of the first cannula 116 should have for an easy outflow.

The reagent container 108 comprises a body 132, a cap 134, a cap cover (i.e. cover) 162 and a membrane 164. The cap cover 162 has a cage 166, a first protruding part 168 and a second protruding part 170. The cage 166 further has a left portion 172, a top portion 174 and a right portion 176 so that the cage 166 is contoured for completely sealing the opening of the body 132 near the top side 142 of the reagent container 108. The protruding parts 168 and 170 are located on the bottom surface of the top portion 174. The right portion 176 of the cage 166 is tied to the right side 140 near the opening with a rope 178. Before usage, the cap cover 162 is attached to the cap 134 for covering the opening of the body 132 and sealing the reagent 110. During usage, the cap cover 162 is removed from the cap 134 by rotating cap cover 162 around the rope 178 and then flipped upside down with the bottom surface of the top portion pointing upward. A first hole 180 and a second hole 182 are exposed from the cap 134. During the process, the first protruding part 168 and the second protruding part 170 are taken out of the first hole 180 and the second hole 182 respectively. When the cannulas 116 and 118 are pushed toward the reagent container 108, the first cannula 116 and the second cannula 118 would be inserted into the first hole 180 and the second hole 182 respectively, and further peered through the membrane 164.

The membrane 164 is located inside the body 132 and below the cap cover 162. The reagent 110 is contained below the membrane 164 that protects the reagent 110 from contamination. Since the membrane 164 may be in contact with the reagent 110, the membrane 164 is particularly made of chemically stable plastics, such as polypropylene (PP), polytetrafluoroethene (PTFE), polyethylene terephthalate (PETG) or any combination thereof. The membrane 164 should not so hard and stiff such that it can be peered through by the plastic cannulas 116 and 118 before the stored solvent 106 is injected into the reagent container 108. In particular, the membrane 164 has a textured surface and a pre-determined thickness such that the membrane 164 can substantially recovers to the original state as an intact membrane and then seals the reagent container 108 again after the cannulas 116 and 118 are withdrawn from the membrane 164. After the stock solution is prepared in the reagent container 108, the cap cover 162 and the membrane 164 are both closed to provide a double sealing mechanism for preventing the stock solution from leakage. Preferably, the membrane may have a thickness ranging from 0.1 mm to 5 mm. In addition, the membrane may have a plurality of pores that help the membrane to recover after the cannulas are withdrawn from the membrane. Preferably, the membrane 164 may have a thickness ranging from 0.1 mm to 5 mm. In addition, the membrane 164 may have at least one pore 184 for helping the membrane 164 to recover. The size of the pore 184 ranges from 0.1 micrometer to 10 micrometers.

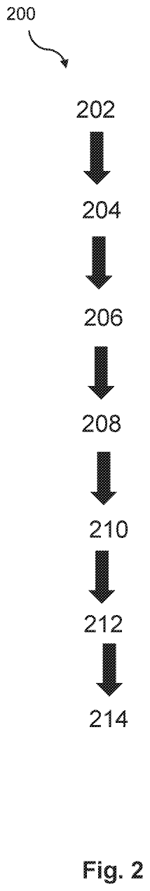

FIG. 2 shows a method of using the first sterile and safe reagent preparation device 102 according to a second embodiment 200 of the present application. The method comprises a first step 202 of removing the cap cover 162 from the cap 134 of the reagent container 108. In the first step 202, the protruding parts 168 and 170 are removed from the holes 180 and 182 of the cap 134. The method comprises a second step 204 of removing the protective lid 158 from the second end 156 of each cannula 116 or 118 of the liquid reservoir 104. The method comprises a third step 206 of inserting the cannulas 116 and 118 into the holes 180 and 182 of the cap 134 accordingly, and further peer through the membrane 164. The method comprises a fourth step 208 of opening the flipper 114 by pushing the movable shell 112 forward or pulling the head 120 backward from the full position 128 to the empty position 130. The method comprises a fifth step 210 of injecting the stored solvent 106 into the reagent container 108 by flowing across the flipper 114 to the conduit 146 and the first cannula 116. Meanwhile, the toxic air inside the reagent container 108 is transferred into the liquid reservoir 104 through the second cannula 118, the conduit 146 and across the flipper 114. The toxic air is prevented from leakage outside to the surrounding environment. The method comprises a sixth step 212 of withdrawing the liquid reservoir 104 from the reagent container 108 by extracting the cannulas 116 and 118 out of the membrane 164 and the holes 180 and 182 of the cap 134. And the method may comprise a seventh step 214 of resetting the flipper 114 by pulling the movable shell 112 backward from the empty position 130 to the full position 128.

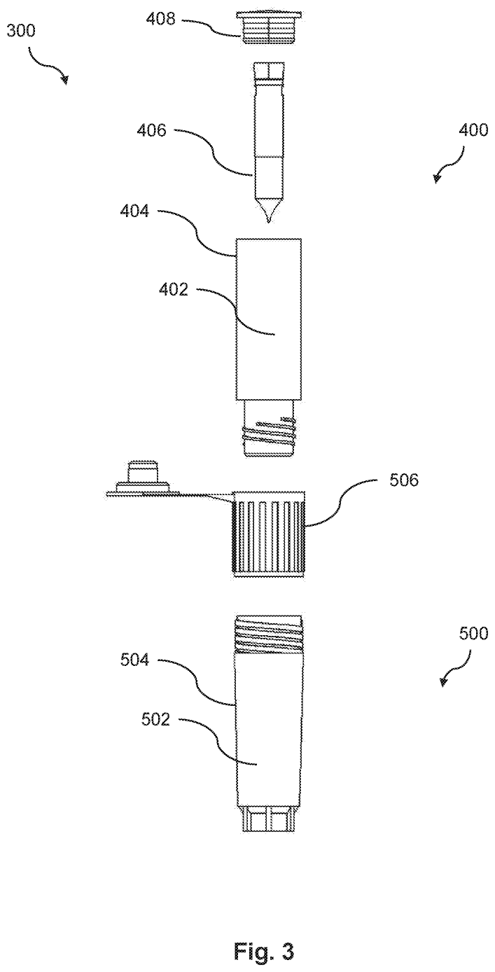

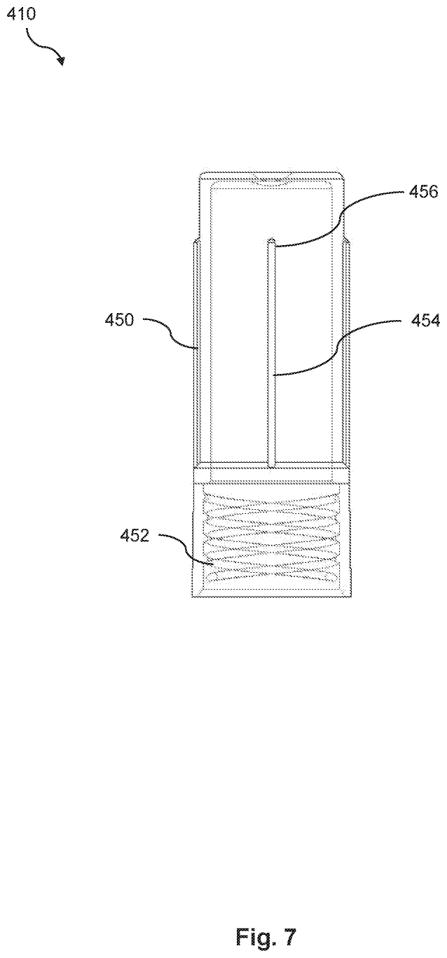

FIG. 3 illustrates an exploded view of a second embodiment of the sterile and safe reagent preparation device 300 (i.e. second sterile and safe reagent preparation device). The second sterile and safe reagent preparation device 300 comprises a liquid storage 400 for storing a liquid 402; and a reagent container 500 for containing a reagent 502. The liquid storage 400 and the reagent container 500 are configured to be detachably engaged. Before the engagement, the liquid storage 400 and the reagent container 500 are filled with the liquid 402 and the reagent 502, respectively. The liquid storage 400 and the reagent container 500 may also be kept in inventory and maybe transported independently. The liquid storage 400 and the reagent container 500 are engaged for preparing a reagent solution by making the liquid 402 to flow into the reagent container 500 for dissolving the reagent 502 in the reagent container 500. The liquid storage 400 and the reagent container 500 are made of polypropylene (PP) that is chemically stable to most liquids 402 (such as chemical solvents) and reagent 502 (such as toxic chemicals). After the engagement, the liquid storage 400 is detached and removed from the reagent container 500. The reagent solution is finally transferred out of the reagent container 500. In this way, the reagent solution is prepared without any human contact or other external interference. In addition, the reagent solution is also prepared with a precise control of its volume and concentration of the reagent 502. The liquid storage 400 comprises a shell 404, a communication part 406, an opening cover 408 and a lid 410 (shown FIG. 7) for sealing the liquid 402 inside the shell 404; while the reagent container 500 comprises a body 504 and a cap 506 for sealing the reagent 502 inside the body 504.

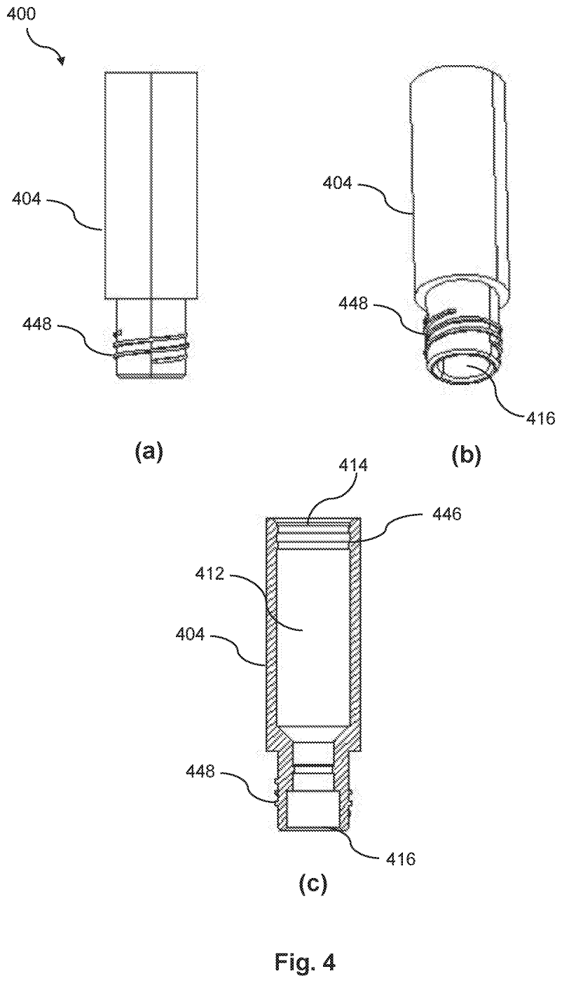

FIG. 4 illustrates the liquid storage 400, showing a side view in FIG. 4(a), an isometric view in FIG. 4(b) and a cross-sectional view in FIG. 4(c). The shell 404 encloses a liquid space 412 for storing the liquid 402. The shell 404 of the liquid storage 400 has a first opening 414 at a top end of the shell 404 and a second opening 416 at a bottom end of the shell 404 opposed to the first opening 414. The first opening 414 and the second opening 416 are used for filling in the liquid 402 into the liquid space 412 before the engagement and for accommodating the communication part 406 when the communication part 406 is extended out of the shell 404. Before the engagement, the opening cover 408 and the lid 410 (shown in FIG. 7) seal the first opening 414 and the second opening 416, respectively. In particular, the liquid storage 400 has a first male screw thread 448 proximate to the second opening 416. The liquid space 412 has approximately a cylindrical dimension with a diameter of around 10 millimeter (mm) and a height of around 30 millimeter (mm). Therefore, the liquid storage 400 can store up to around 2.5 milliliter (ml) of the liquid 402 in the storage space.

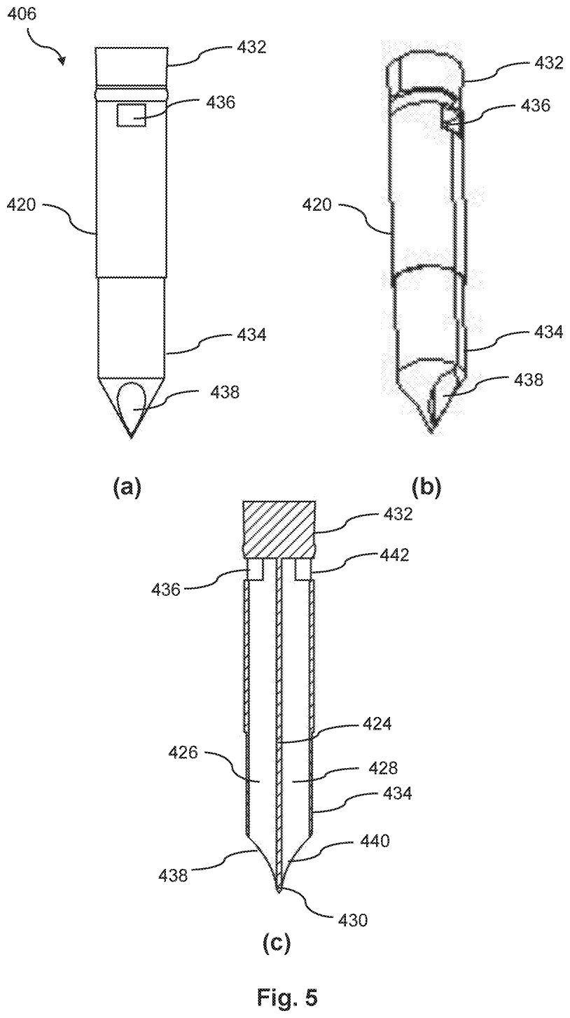

FIG. 5 illustrates the communication part 406, showing a side view in FIG. 5(a), an isometric view in FIG. 5(b) and a cross-sectional view in FIG. 5(c). The communication part 406 is used for communicating the liquid 402 and a gas or gaseous substance 218 (not shown) between the liquid storage 400 and the reagent container 500. The communication part 406 comprises a case 420 defining an internal cavity 422 and a baffle 424 for separating the internal cavity 422 into a first passageway 426 and the second passageway 428. The first passageway 426 and the second passageway 428 are exclusively used for draining off the liquid 402 stored in the liquid storage 400 and for relieving the gas 418 from the reagent container 500, respectively. In other words, the first passageway 426 and the second passageway 428 are separated by the baffle 424. In particular, the baffle 424 has a baffle edge 430 shaper enough for piercing through the reagent container 500. The baffle edge 430 has a cut angle of 45 degrees. FIG. 5 shows a schematic diagram of the first passageway 426 and the second passageway 428 only and does not indicate their relative dimensions.

The communication part 406 has a first end 432 inside the shell 404 and a second end 434 opposed to the first end 432. The second end 434 protrudes out of the shell 404 and is proximate to the baffle edge 430. In addition, the communication part 406 has a first inlet 436 and a second outlet 442 near the first end 432 for the fluid 402 and the gas 418 to flow into and out of the first passageway 426 and the second passageway 428, respectively. The communication part 406 also has a first outlet 438 and the second inlet 440 near the second end 434 for the fluid and the gas 418 to flow out of and into the first passageway 426 and the second passageway 428, respectively. In this way, the fluid flows from the liquid space 412 into the first passageway 426 via the first inlet 436 at the first end 432, through the first passageway 426, and then out of the first passageway 426 via the first outlet 438 at the second end 434. Similar, the gas 418 flows from the reagent container 500 into the second passageway 428 via the second inlet 440 at the second end 434, through the second passage 428, and then out of the second passageway 428 via the second outlet 442 at the first end 432.

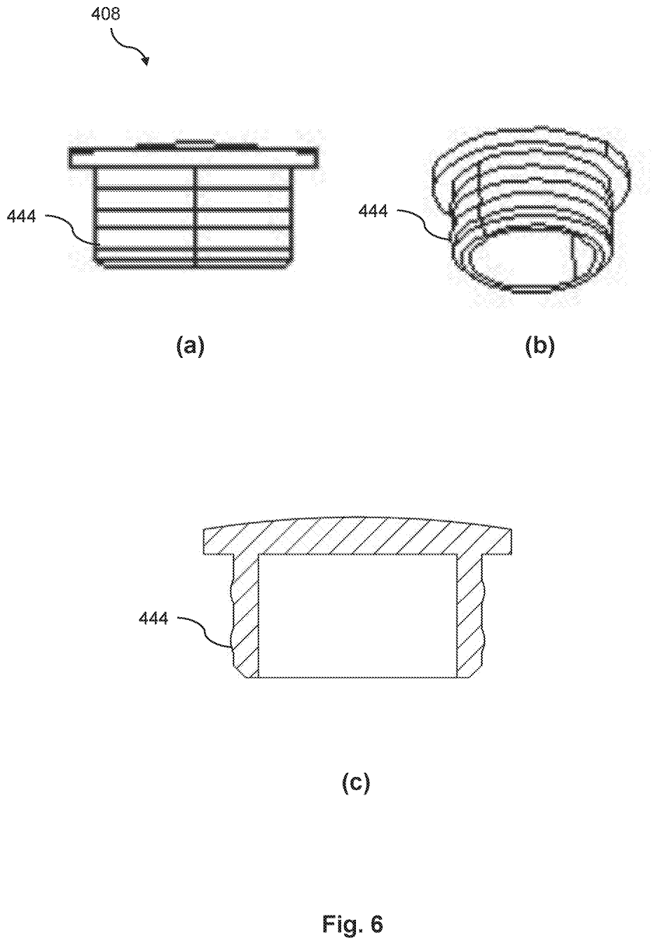

FIG. 6 illustrates the opening cover 408, showing a side view in FIG. 6(a), an isometric view in FIG. 6(b) and a cross-sectional view in FIG. 6(c). The opening cover 408 is used for sealing the first opening 414 of the liquid storage 400. In particular, the liquid storage 400 has an internal screw thread 446 (shown in FIG. 4(c)) proximate to the first opening 414 and the opening cover 408 has an external screw thread 444 that matches the internal screw thread 446. In this way, the opening cover 408 tightly seals the first opening 414 without any leakage by engaging the external screw thread 444 to the internal screw thread 446.

FIG. 7 illustrates the lid 410 of the liquid storage 400 for sealing the second opening 416 of the liquid storage 400 before the liquid storage 400 is engaged with the reagent container 500. The lid 410 comprises a housing 450, a lid screw thread 452 at one end of the housing and a slit 454 inside the housing 450. The lid 410 and the liquid storage 400 are connected by engaging the lid screw thread 452 to the first male screw thread 448 of the liquid storage 400. Meanwhile, the baffle 424 is inserted into the slit 454. The slit 454 has a closed end 456 for protecting the sharp baffle edge 430. Therefore, the lid 410 protect the communication part 406, particularly the sharp baffle edge 430 during shipment of the liquid storage 400. Before the engagement, the lid 410 is removed from the liquid storage 400 by disengaging the lid screw thread 452 from the first male screw thread 448.

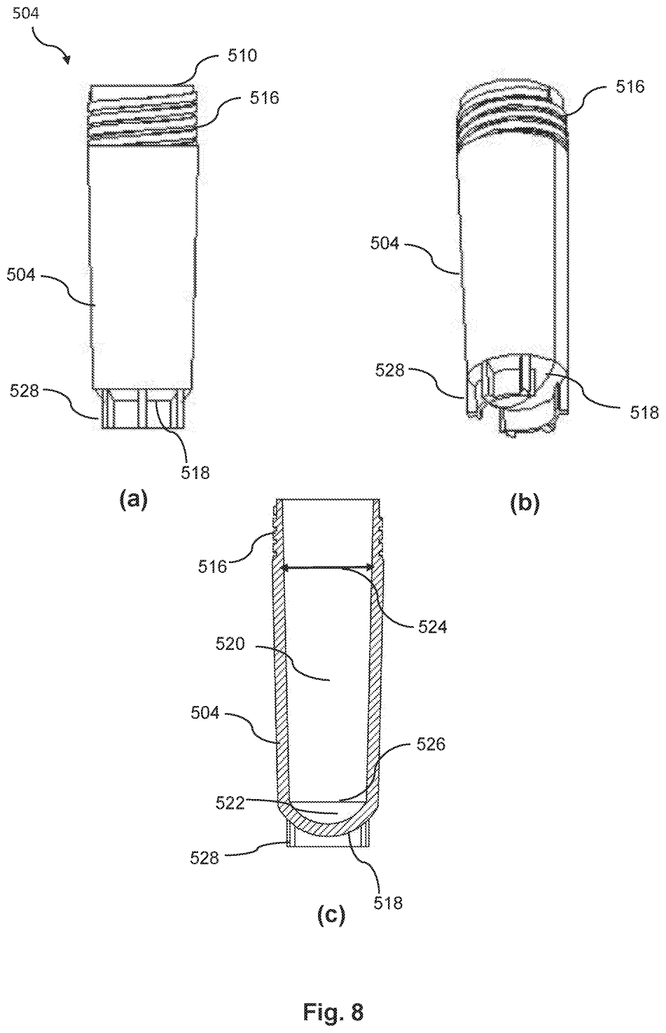

FIG. 8 illustrates the body 504 of the reagent container 500, showing a side view in FIG. 8(a), an isometric view in FIG. 8(b) and a cross-sectional view in FIG. 8(c). In addition, the reagent container 500 further comprises a membrane 508 near the cap 506 (not shown). The body 504 encloses a reagent space 512 for storing the reagent 502 (not shown). The reagent container 500 has a container opening 510 for filling in the reagent 502 into the reagent space 512 during the engagement and also for transferring the reagent solution out of the reagent container 500 after the engagement. Both the cap 506 and the membrane 508 are used to seal the container opening 510. The body 504 has a second male screw thread 516 proximate to the container opening 510. In contrast to the liquid storage 400, the reagent container 500 does not have an opening opposed to the container opening 510. The reagent 502 is thus filled into the reagent space 512 through the container opening 510 before the membrane 508 is attached to the reagent container 500 proximate to the container opening 510.

In particular, the reagent container 500 has a round bottom 518 opposed to the container opening 510. Therefore, the reagent space 512 is divided into a first space portion 520 approximate to a conical dimension and a second space portion 522 approximate to a meniscus dimension. The first space portion 520 has a first diameter of around 10 millimeter (mm) at its widest end 524 and a second diameter of around 8.6 millimeter (mm) at its narrowest end 526. The first space portion 520 also has a first height of around 41.5 millimeter (mm). The first space portion 520 thus has a first capacity of around 2.8 milliliter (ml) large enough for accommodating the liquid stored in the liquid storage 400. The second space portion 522 has a second capacity negligible to the first capacity.

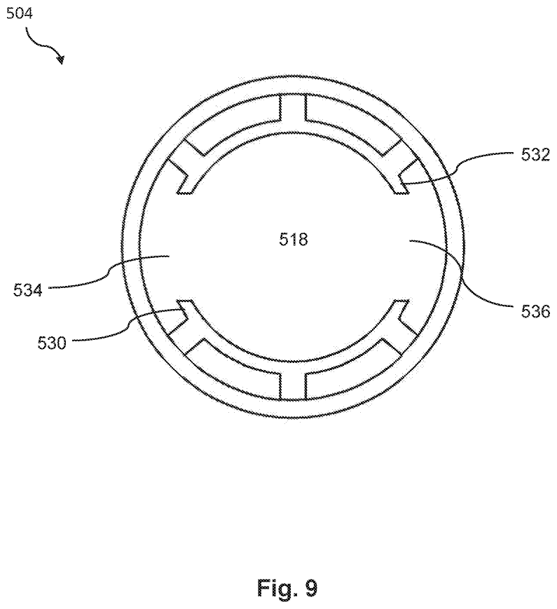

The reagent container 500 also has a plinth 528 beneath the round bottom 518 for the reagent container 500 to stand freely without being hold by an operator before, during or after the engagement. Therefore, multiple sterile and safe reagent preparation devices 300 can be handled by the operator. FIG. 9 illustrates a bottom view of the body 504 of the reagent container 500. The plinth 528 has a first plinth unit 530 and a second plinth unit 532 that are separated by a first gap 534 and a second gap 536. The gaps 534, 536 are for automation assembly to hold and turn the reagent container.

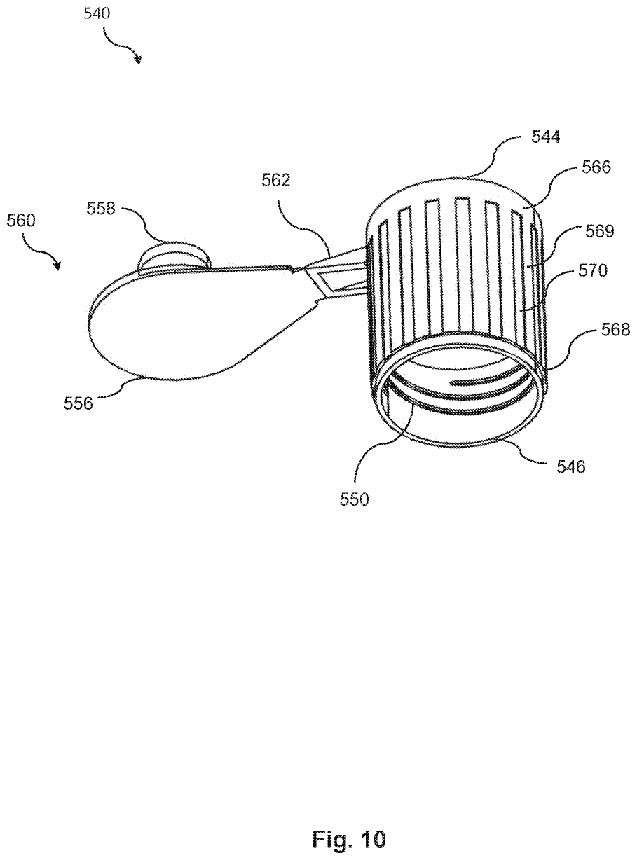

FIG. 10 illustrates an isometric view of a first embodiment 540 of the cap 506 having a container cover 560. The cap 506 has a spacer 542 (not shown) that divides the cap 506 into a top cap unit 544 and a bottom cap unit 546. The top cap unit 544 has a first female screw thread 548 (not shown) matching the first male screw thread 448 of the liquid storage 400; and a second female screw thread 550 for matching the second male screw thread of the body 504. The liquid storage 400 and the reagent container 500 are tightly engaged without any leakage before the liquid 402 flows from the liquid storage 400 into the reagent container 500 via the second opening 416 of the liquid storage 400 and the container opening 510 of the reagent container 500. The container cover 560 connected to a periphery of the top cap unit 544 by a linkage 562. The cap 506 further has eighteen protrusions 569 extending on a first outside surface 566 of the top cap unit 544 and a second outside surface 568 of the bottom cap unit 546. In other words, the eighteen protrusions cross the spacer 542 continuously. A trench 570 is thus formed between every two immediately adjacent protrusions. Therefore, eighteen trenches 570 are formed on the first outside surface 566 and the second outside surface 568. The eighteen trenches 570 provides an abrasive force for turning the cap.

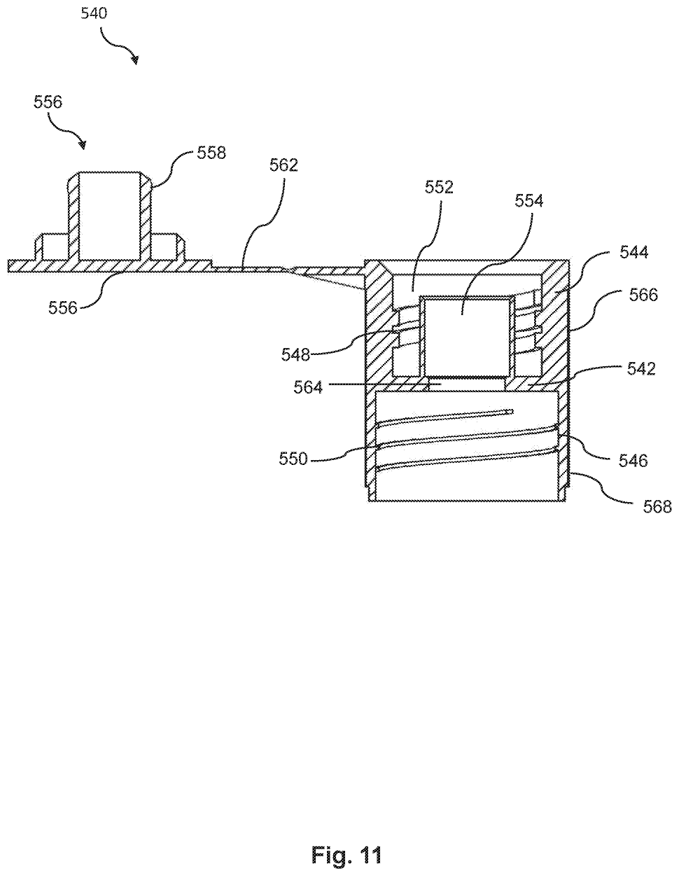

FIG. 11 illustrates a perspective view of the cap 506. In particular, the cap 506 has a first cylinder 552 inside the top cap unit 544. The first cylinder 552 has a tunnel 554 throughout the first cylinder 552. The spacer 542 also has an aperture 564 aligned with the tunnel 554. Therefore, the liquid 402 flows from the first outlet 438 of the communication part 406, through the tunnel 554, the aperture 564 and the bottom cap unit 546, and finally into the body 504. The container cover 560 is used to seal the cap 506 before the engagement. The container cover 560 has a slab 556 completely covering the top cap unit 544 and a second cylinder 558 that is configured to be fit into the tunnel 554. Therefore, the container cover 560 has dual sealing effect, i.e. a first sealing by the slab 556 to the top cap unit 544 and a second sealing by the second cylinder 558 to the tunnel 554.

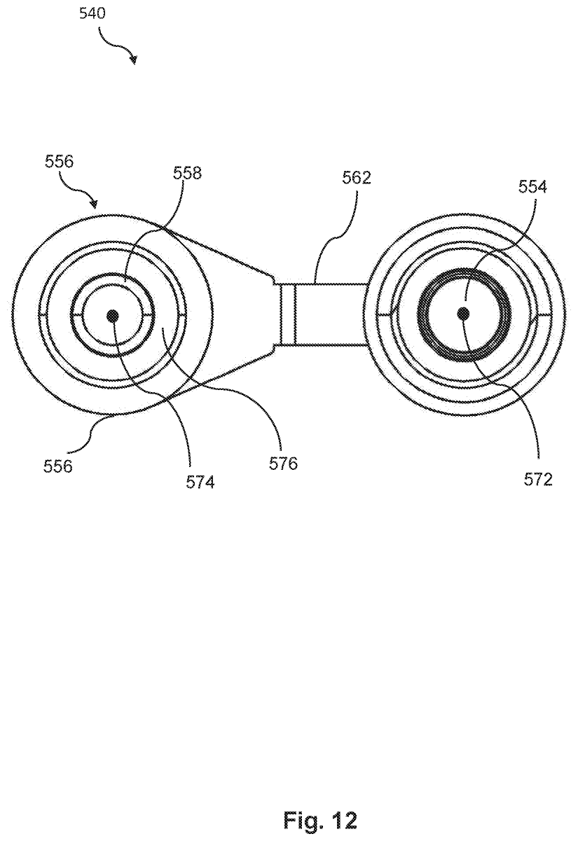

FIG. 12 illustrates a top view of the cap 506. The top cap unit 544 and the bottom cap unit 546 are configured to be concentric to a first center 572. The first cylinder 552 and the tunnel 554 are also concentric to the first center 572. Similarly, the slab 556 and the second cylinder 558 is also concentric to a second center 574. When the container cover 560 is closed to the cap 506, the first center 572 and the second coincide.

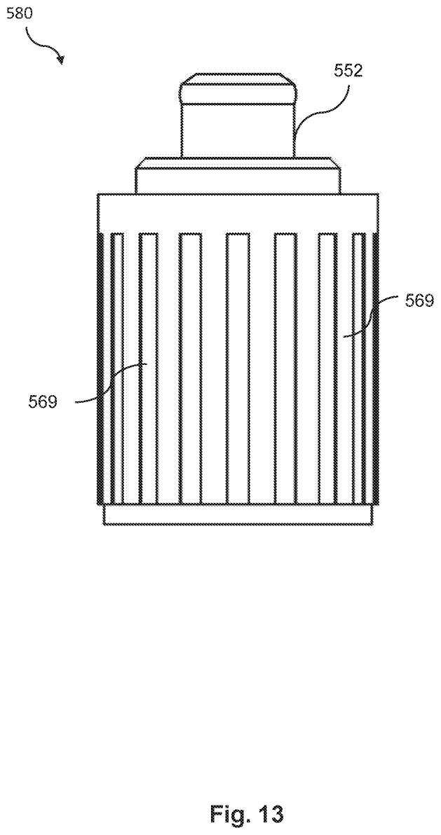

FIG. 13 illustrates a perspective view of a second embodiment 580 of the cap 506. The cap 506 has a similar structure with that of the first embodiment 540 except that the first cylinder 552 is protruded outside the top cap unit. It is clearly seen that the eighteen protrusions 569 or the eighteen trenches 570 are uniformly distributed around the cap 506.

In either the first embodiment 540 or the second embodiment 580. The container cover 560 has a recess 576 (as shown in FIG. 12 for the first embodiment 540) around the second cylinder 558. The recess 576 has a size matching an inner diameter of the top cap unit 544. The top cap unit 544 thus is slightly trapped inside the recess 576 for sealing the top cap unit 544 better. It is clearly seen in FIG. 12 that the recess 576 is around concentric to the second center 574.

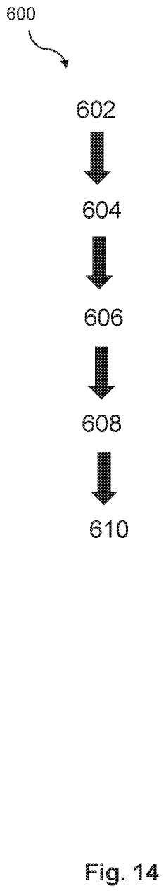

FIG. 14 illustrates a flowchart of a method 600 of using the second sterile and safe reagent preparation device 300. The method 600 of using the sterile and safe reagent preparation device comprises a first step 602 of providing a liquid storage 400 for storing a liquid 402; a step 604 of providing a reagent container 500 for containing a reagent 502; a third step 606 of engaging the liquid storage 400 to the reagent container 500; a fourth step 608 of transferring the liquid 402 from the liquid storage 400 to the reagent container 500; and a fifth step 610 of detaching the liquid storage 400 from the reagent container 500.

In the application, unless specified otherwise, the terms “comprising”, “comprise”, and grammatical variants thereof, intended to represent “open” or “inclusive” language such that they include recited elements but also permit inclusion of additional, non-explicitly recited elements.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. The description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

It will be apparent that various other modifications and adaptations of the application will be apparent to the person skilled in the art after reading the foregoing disclosure without departing from the spirit and scope of the application and it is intended that all such modifications and adaptations come within the scope of the appended claims.

### REFERENCE NUMERALS

100 first embodiment
102 first sterile and safe reagent preparation device
104 liquid reservoir;
106 (stored) solvent
108 reagent container
110 reagent
112 movable shell
114 flipper
116 first cannula
118 second cannula
120 head
122 bottom side
124 left side
126 right side
128 full position (not shown)
130 empty position (not shown)
132 body
134 cap
136 bottom side
138 left side
140 right side
142 top side
144 frame
146 conduit
148 first portion
150 second portion
152 dent
154 first end
156 second end
158 protective lid (not shown)
160 air exchange (not shown)
162 (cap) cover or cap cover
164 membrane
166 cage
168 first protruding part
170 second protruding part
172 left portion
174 top portion
176 right portion
178 rope
180 first hole
182 second hole
184 pore (not shown)
200 second embodiment
202 first step
204 second step
206 third step
208 fourth step
210 fifth step
212 sixth step
214 seventh step
300 second sterile and safe reagent preparation device (second embodiment);
400 liquid storage;
402 liquid;
404 shell;
406 communication part;
408 opening cover;
410 lid;
412 liquid space;
414 first opening;
416 second opening;
418 gas;
420 case;
422 internal cavity;
424 baffle;
426 first passageway;
428 second passageway;
430 baffle edge;
432 first end;
434 second end;
436 first inlet;
438 first outlet;
440 second inlet;
442 second outlet;
444 external screw thread;
446 internal screw thread;
448 first male screw thread;
450 housing;
452 lid screw thread;
454 slit;
456 closed end;
500 reagent container;
502 reagent;
504 body;
506 cap;
508 membrane;
510 container opening;
512 reagent space;
516 second male screw thread;
518 round bottom;
520 first space portion;
522 second space portion;
524 widest end;
526 narrowest end;
528 plinth;
530 first plinth unit;
532 second plinth unit;
534 first gap;
536 second gap;
540 first embodiment (of the cap);
542 spacer;
544 top cap unit;
546 bottom cap unit;
548 first female screw thread;
550 second female screw thread;
552 first cylinder;
554 tunnel;
556 slab;
558 second cylinder;
560 container cover;
562 linkage;
564 aperture;
566 first outside surface;
568 second outside surface;
569 protrusion;
570 trench;
572 first center;
574 second center;
576 recess;
580 second embodiment (of the cap);
600 method of using the second sterile and safe reagent preparation device;
602 first step;
604 second step;
606 third step;
608 fourth step;
610 fifth step.

While non-limiting exemplary embodiment(s) has/have been described with respect to certain specific embodiment(s), it will be appreciated that many modifications and changes may be made by those of ordinary skill in the relevant art(s) without departing from the true spirit and scope of the present disclosure. It is intended, therefore, by the appended claims to cover all such modifications and changes that fall within the true spirit and scope of the present disclosure. In particular, with respect to the above description, it is to be realized that the optimum dimensional relationships for the parts of the non-limiting exemplary embodiment(s) may include variations in size, materials, shape, form, function and manner of operation.

The Abstract of the Disclosure is provided to comply with 37 C.F.R. § 1.72(b) and is submitted with the understanding that it will not be used to interpret or limit the scope or meaning of the claims. In addition, in the above Detailed Description, various features may have been grouped together or described in a single embodiment for the purpose of streamlining the disclosure. This disclosure is not to be interpreted as reflecting an intention that the claimed embodiment(s) require more features than are expressly recited in each claim. Rather, as the following claims reflect, inventive subject matter may be directed to less than all of the features of any of the disclosed non-limiting exemplary embodiment(s). Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiment(s) which fall within the true spirit and scope of the present disclosure. Thus, to the maximum extent allowed by law, the scope of the present disclosure is to be determined by the broadest permissible interpretation of the following claims and their equivalents, and shall not be restricted or limited by the above detailed description.

What is claimed as new and what is desired to secure by Letters Patent of the United States is:

1. A reagent preparation device for sterilization and safety, comprising:
a liquid storage for storing a liquid; and
a reagent container for containing a reagent hermetically;
wherein the liquid storage and the reagent container are configured to be engaged together in forming an enclosure for mixing the liquid and the reagent.

2. The reagent preparation device of claim 1, wherein the reagent container has an impermeable membrane for sealing the reagent container to avoid the reagent out of the reagent container.

3. The reagent preparation device of claim 1, wherein the liquid storage has a volume capacity ranging substantially from one (1) milliliter (ml) to one hundred (100) milliliter (ml) substantially.

4. The reagent preparation device of claim 1, wherein the liquid storage comprises: a communication part for the liquid to flow through from the liquid storage to the reagent container.

5. The reagent preparation device of claim 4, wherein the communication part comprises:
a first passageway for draining off the liquid stored in the liquid storage; and
a second passageway for relieving gas from the reagent container;
wherein the first passageway and the second passageway are substantially separated.

6. The reagent preparation device of claim 4, wherein the communication part further comprises:
a first inlet and a first outlet for the liquid to flow into and out of the first passageway respectively; and
a second inlet and a second outlet for the gas to flow into and/or out of the second passageway, respectively.

7. The reagent preparation device of claim 5, wherein the first passageway and the second passageway have a first cross-sectional area and a second cross-sectional area respectively;
wherein an area ratio of the first cross-sectional area to the second cross-sectional area ranges from 1.5 (one point five) to 64 (sixty-four) substantially.

8. The reagent preparation device of claim 4, wherein the communication part further comprises:
a case defining an internal cavity; and
a baffle inside the case for separating the internal cavity into the first passageway and the second passageway.

9. The reagent preparation device of claim 8, wherein the baffle has a baffle edge for piercing through the membrane.

10. The reagent preparation device of claim 4, wherein the communication part comprises:
a head configured to be assembled onto the liquid storage;
a first cannula extending from the head as the first passageway; and
a second cannula further extending from the head as the second passageway.

11. The reagent preparation device of claim 10, wherein a diameter ratio of a first internal diameter of the first cannula and a second internal diameter of the second cannula ranges from 1.2 (one point two) to 8.0 (eight point zero) substantially.

12. The reagent preparation device of claim 1, wherein the liquid storage further comprises:
a frame enclosing the conduit; and
a flipper connected to the conduit for sealing and/or releasing the liquid.

13. The reagent preparation device of claim 1, wherein the reagent container comprises: a cap detachable from the reagent container.

14. The reagent preparation device of claim 13, wherein the cap comprises:
a first fastening mechanism for detachably fastening the cap to the reagent container; and
a second fastening mechanism for detachably fastening the cap to the liquid storage.

15. The reagent preparation device of claim 4, wherein the communication part is made of chemically stable plastics.

16. A method of making a reagent preparation device for sterilization and safety, comprising: the steps of
providing a liquid storage for storing a liquid; and
providing a reagent container for containing a reagent;
wherein the liquid storage and the reagent container are configured to be detachably engaged.

17. The method of claim 16, wherein the step of providing the liquid storage comprises: the steps of
providing a communication part; and
assembling the communication part for the liquid to flow through from the liquid storage to the reagent container.

18. The method of claim 17, wherein the step of providing the communication part comprises:
making a baffle in the communication part for forming a first passageway for draining off the liquid and a second passageway for reliving a gas from the reagent container.

19. A method of using a reagent preparation device for sterilization and safety, comprising: the steps of
providing a liquid storage for storing a liquid;
providing a reagent container for containing a reagent;
engaging the liquid storage to the reagent container;
transferring the liquid from the liquid storage to the reagent container; and
detaching the liquid storage from the reagent container.

20. The method of claim 19, wherein the step of engaging the liquid storage comprises: piercing a membrane of the reagent container using a communication part of the liquid storage.

21. The method of claim 19, wherein the step of transferring the liquid comprises: injecting the liquid via the communication part of the liquid storage.
